(19) United States
(12) Patent Application Publication
(10) Pub. No.: US 2011/0314235 A1
(43) Pub. Date: Dec. 22, 2011

(54) DATA STORAGE DEVICE AND WRITE METHOD THEREOF

(75) Inventors: Hyuck-Sun KWON, Seoul (KR); KyoungLae Cho, Yongin-si (KR)

(73) Assignee: Samsung Electronics Co., Ltd., Suwon-si (KR)

(21) Appl. No.: 13/163,874

(22) Filed: Jun. 20, 2011

(30) Foreign Application Priority Data
Jun. 18, 2010 (KR) 10-2010-0058196

(51) Int. Cl. G06F 12/00

(52) U.S. Cl. 711/154; 711/E12.001

(57) ABSTRACT

A data storage device that includes a storage media, and a controller to compress raw data to be stored in the storage media, wherein the controller can add header and/or footer information to the compressed data. The controller of the data storage device can further change stored, compressed data by retrieving all or only some of the compressed stored data, uncompressing it, adding or changing the now uncompressed data, and then re-compressing it before adding either or both of header and footer to the compressed data. The storage media can be solid state devices, and can be used with a controller in a computer or a server, that can be part of any one or a multitude of types of networks, including, for example, an internet.

### CROSS-REFERENCE TO RELATED APPLICATIONS

This application claims the benefits, under 35 U.S.C §119, of Korean Patent Application No. 10-2010-0058196 filed Jun. 18, 2010, the entirety of which is incorporated by reference herein.

### BACKGROUND OF THE INVENTION

1. Field of the Invention

Exemplary embodiments relate to data storage devices, and more particularly, relate to a system and method to compress data prior to storing it in a data storage device.

2. Description of the Related Art

As it is known in the art, computer systems generally use several types of memory systems. For example, computer systems generally use a main memory comprised of semiconductor devices typically having the attribute that the devices can be randomly written to and read from with comparable and very fast access times, and thus are commonly referred to as random access memories (RAM). However, since semiconductor memories are relatively expensive, other high density and low cost memories are often used. For example, other memory systems include magnetic disk storage systems. In the case of magnetic disk storage systems, generally, access times are in the order of tens of milliseconds, which is relatively slow. On the other hand, in case of main memory that are comprised of semiconductor devices, the access times are in the order of hundreds of nanoseconds, which is significantly faster than the access times for magnetic disk storage systems. Disk storage is typically used to store large quantities of data which can be sequentially read into main memory as needed. Another type of disk-like storage is solid state disk storage (“SSD”, which is also called “solid state drive”). SSD is a data storage device that uses memory chips, such as SDRAM, to store data, instead of the spinning platters found in conventional hard disk drives.

The term “SSD” is used for two different kinds of products. The first type of SSD, based on fast, volatile memory such as synchronous dynamic RAM (SDRAM), is categorized by extremely fast data access, and is used primarily to accelerate applications that are held back by the latency of disk drives. Since this type of SSD uses volatile memory, it typically incorporates an internal battery and backup disk systems to ensure data persistence. If power is lost for whatever reason, the battery keeps the unit powered long enough to copy all data from the SDRAM to a backup disk. Upon the restoration of power, data is copied back from the backup disk to the SDRAM and the SSD resumes normal operation. The first type of SSD is especially useful on a computer which is already has the maximum amount of RAM. The second type of SSD uses flash memory to store data and is generally used in replacement of a hard disk drive.

Because SSD memory is very fast, its use is generally preferred over that of hard disk drives. Since it is also very costly, its use has been limited. A system and method to increase storage capacity of SSD memory would make it less costly to use SSD memory because less memory would have to be purchased.

### SUMMARY OF THE INVENTION

The present general inventive concept provides a data storage device which comprises a storage media; and a controller to compress raw data to be stored in the storage media, wherein the controller adds header information to the compressed data.

The foregoing and/or other features and utilities of the present general inventive concept may be achieved by providing a write method of a data storage device including a storage media; and a controller to control the storage media. The write method comprises configuring raw data to be stored in the storage media to logical units; compressing raw data of the logical units, respectively; adding header information to compressed data of each of the logical units; and continuously storing the compressed data of the respective logical units each having the header information in physical units of the storage media.

### BRIEF DESCRIPTION OF THE DRAWINGS

The above and other features and utilities of the present general inventive concept will become apparent and more readily appreciated from the following description of the embodiments with reference to the following figures, wherein like reference numerals refer to like parts throughout the various figures unless otherwise specified, and wherein

These and/or other aspects and advantages of the present general inventive concept will become apparent and more readily appreciated from the following description of the embodiments, taken in conjunction with the accompanying drawings of which:

FIG. 1 is a block diagram showing a data storage device according to an exemplary embodiment of the inventive concept.

FIG. 2 is a block diagram showing a controller illustrated in FIG. 1 according to an exemplary embodiment of the present general inventive concept.

FIG. 3 is a block diagram showing a storage media illustrated in FIG. 1 according to an exemplary embodiment of the present general inventive concept.

FIG. 4 is a flow chart for describing a write operation of a data storage device according to an exemplary embodiment of the present general inventive concept.

FIG. 5 is a diagram showing data flow according to a write method in FIG. 4.

FIG. 6 is a diagram showing data flow according to a write method according to another exemplary embodiment of the present general inventive concept.

FIG. 7 is a flow chart for describing a write operation of a data storage device according to another exemplary embodiment of the present general inventive concept.

FIG. 8 is a flow chart for describing a write operation of a data storage device according to still other exemplary embodiments of the present general inventive concept.

FIG. 9 is a block diagram showing a compression block illustrated in FIG. 2 according to an exemplary embodiments of the present general inventive concept.

FIG. 10 a block diagram showing a compression block illustrated in FIG. 2 according to another exemplary embodiments of the present general inventive concept.

FIG. 11 is a block diagram showing a compression block illustrated in FIG. 2 according to another exemplary embodiments of the present general inventive concept.

FIG. 12 is a block diagram showing a storage using a Solid State Drive (SSD) as a data storage device according to an exemplary embodiment of the present general inventive concept.

FIG. 13 is a block diagram showing a storage server using SSD illustrated in FIG. 12.

FIG. 14 is a block diagram showing a storage according to another exemplary embodiment of the present general inventive concept.

FIG. 15 is a block diagram showing a storage server using a storage in FIG. 14.

FIGS. 16 to 18 are diagrams showing systems to which a data storage device according to exemplary embodiments of the present general inventive concept is applied.

### DETAILED DESCRIPTION OF THE PREFERRED EMBODIMENTS

The inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

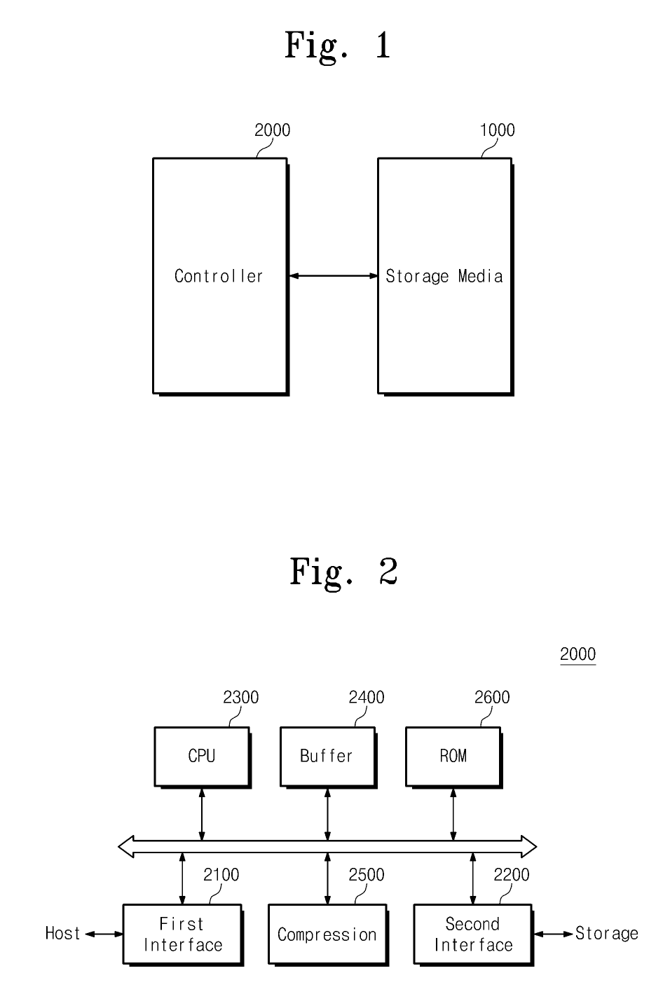

FIG. 1 is a block diagram showing a data storage device according to an exemplary embodiment of the present general inventive concept.

Referring to FIG. 1, a data storage system includes a storage media 1000 and a controller 2000. The storage media 1000 is used to store data information having various types such as texts, graphics, software codes, and the like. The storage media 1000, for example, is formed of a non-volatile memory such as PRAM, FeRAM, MRAM, or the like. But, it is well understood that non-volatile memories applied to the storage media 1000 are not limited to this disclosure.

The controller 2000 is configured to control the storage media 1000 in response to external requests. The controller 2000 is configured to compress data from an external device and to store the compressed data in the storage media 1000. The data compressing method and system according to an exemplary embodiment enables the storage media 1000 to be used with greater efficiency. For example, the storage media 1000 can store a larger amount of data, with compression as discussed herein, without increasing cost. Further, with the data compressing system and method according to an exemplary embodiment, the amount of data that is required to be transferred between the storage media 1000 and the controller 2000 can be reduced, thereby reducing a transfer time taken to transfer data between the storage media 1000 and the controller 2000.

FIG. 2 is a block diagram showing a controller 2000 illustrated in FIG. 1 according to an exemplary embodiment of the present general inventive concept.

Referring to FIG. 2, a controller 2000 comprises the first interface 2100, the second interface 2200, CPU 2300 being a processing unit, a buffer 2400, a compression block 2500, and ROM 2600.

The first interface 2100 is configured to interface with an external device (or, a host). The second interface 2200 is configured to interface with a storage media 1000 illustrated in FIG. 1. As a processing unit, the CPU 2300 is configured to control an overall operation of the controller 2000. For example, the CPU 2300 is configured to execute firmware such as a flash translation layer (FTL) stored in the ROM 2600. As will be described in greater detail below, FTL firmware can be used to manage mapping information. As those of ordinary skill in the art can appreciate, however, the use of FTL firmware is not limited to the specific examples discussed in this disclosure, which are for illustrative purposes only. For example, FTL firmware can also be used to manage wear-leveling, bad blocks, data retention caused due to unexpected power interruption, among other purposes.

The buffer 2400 is used to temporarily store data transferred from an external device via the first interface 2100. The buffer 2400 is used to temporarily store data transferred from the storage media 1000 via the second interface 2200. The compression block 2500 operates responsive to the control of the CPU 2300 (or, the control of the FTL executed by the CPU 2300) and is configured to compress data in the buffer 2400. The compressed data is stored in the storage media 1000 via the second interface 2200. The compressed data can be stored temporarily within the compression block 2500 or within the buffer 2400. The compression block 2500 operates responsive to the control of the CPU 2300 (or, the control of the FTL executed by the CPU 2300) and is configured to decompress data read out from the storage media 1000.

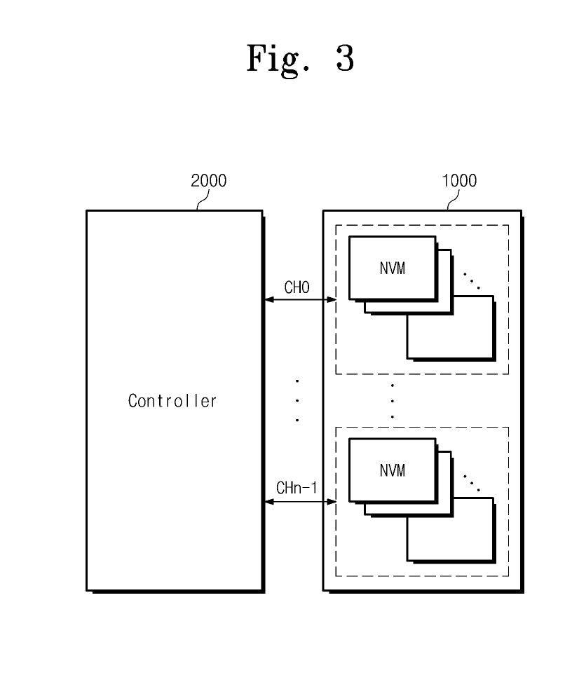

FIG. 3 is a block diagram showing a controller 2000 in FIG. 1 according to an exemplary embodiment of the present general inventive concept.

Referring to FIG. 3, a storage media 1000 operates responsive to the control of a controller 2000. The storage media 1000 is connected with the controller 2000 through a plurality of channels CH0˜CHn−1, each of which is commonly connected with a plurality of non-volatile memories NVM. The controller 2000 is configured to compress data from an external device and store it in the storage medium 1000, and to decompress (or release) compressed data read from the storage media 1000 (which can then be used by the controller 2000, or sent to the host). When transferring data to storage medium 1000, controller 2000 selects the particular NVM according to a channel number, and a device identification number (also known as a “chip” no.). It is also possible during transferring data, that the manner of transfer can be specified, such that in a read/write operation, the manner, channel no., and chip no. all can be specified in the memory read/write operation.

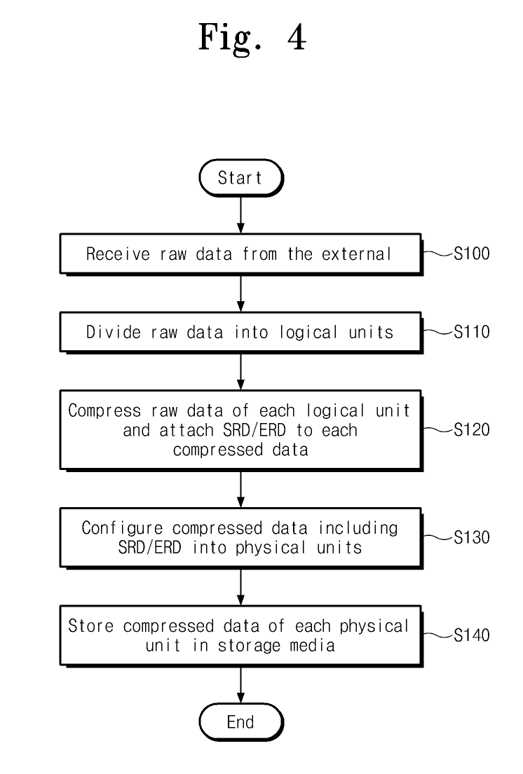

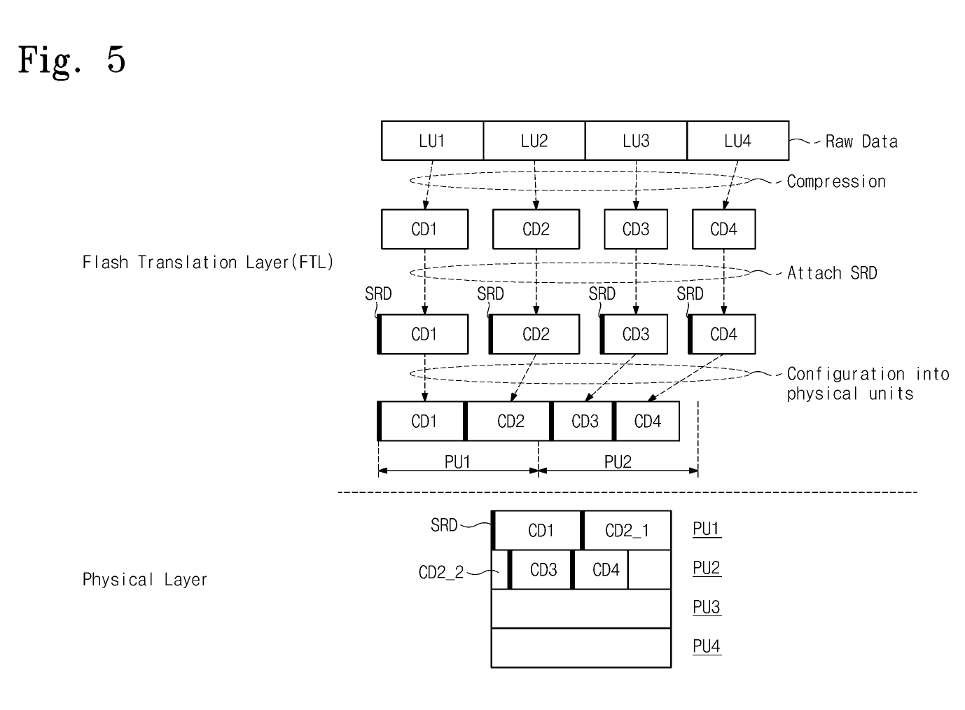

FIG. 4 is a diagram describing a write method of a data storage device according to an exemplary embodiment of the present general inventive concept, and FIG. 5 is a diagram showing data flow when a write method in FIG. 4 is carried out. Below, a write method of a data storage device according to an exemplary embodiment of the inventive concept will be more fully described with reference to accompanying drawings.

Upon receipt of a write request of an external device (for example, a host) by controller 2000, in operation S100, uncompressed/raw data is provided to a data storage device from the external device. The uncompressed/raw data provided to the data storage device is stored in a buffer 2400 via the first interface 2100 under the control of CPU 2300. In operation S110, the uncompressed/raw data stored in the buffer 2400 is divided into a plurality of logical units LU under the control of the CPU 2300 (or, the control of FTL firmware executed by the CPU 2300). For purposes of illustration only, in FIG. 5, there is shown an example uncompressed/raw data that is divided into four logical units LU1˜LU4. However, those of ordinary skill in the art can appreciate that the amount of uncompressed/raw data to be divided into logical units is not limited to this one particular example. Following the division of the uncompressed/raw data, each or the logical units LU can be sent to a compression unit of a compression block 2500.

In operation S120, each of the logical units LU1˜LU4 of the uncompressed/raw data are compressed by the compression block 2500, respectively. To compressed data CD1, as illustrated in FIG. 5, is added header information SRD indicating a “start of uncompressed/raw data” (SRD) of a logical unit LU. Compression of uncompressed/raw data and addition of header information SRD may be successively made with respect to remaining logical units LU2˜LU4. Accordingly, header information SRD is added to compressed data CD corresponding to each of the logical units LU2˜LU4. Compressed data CD including the header information SRD is temporarily stored in a buffer included within the compression block 2500.

In operation S130, each compressed data CD including the header information SRD is configured to physical units PU under the control of the CPU 2300 (or, FTL firmware executed by the CPU 2300). For example, as illustrated in the physical layer portion of FIG. 5, each of compressed data CD1˜CD4 that includes the header information SRD are configured into two physical units, PU1 and PU2. In operation S140, data for each of the physical units PU1 and PU2 is stored in the storage media 1000. According to an exemplary embodiment of the present general inventive concept, compressed data corresponding to one logical unit may be stored whole within one physical unit PU, or stored within two physical units. For example, compressed data CD1 corresponding to a logical unit LU1 is stored whole in a physical unit PU1. A first part CD2_1 of compressed data CD2 corresponding to a logical unit LU2 is stored in PU1, and the remaining portion CD2_2 of the compressed data CD2 is stored in a physical unit PU2. According to a further exemplary embodiment of the present general inventive concept, a size of a logical unit is determined such that compressed data CD corresponding to one logical unit LU is not distributed among three physical units.

Merely for the purpose of convenience, an example has been shown and described with respect to FIG. 5 that the data of physical units PU1 and PU2 is stored in the storage media 1000 following configuration of compressed data CD1˜CD4 into physical units PU1 and PU2. However, those of ordinary skill in the art can appreciate that storing of data into the physical unit (that is, compressed data of SRD-attached logical units) in the storage media 1000 is made whenever a physical unit PU is configured (or, prepared). Alternatively, storing of data into the physical unit (that is, compressed data of SRD-attached logical units) in the storage media 1000 can be made whenever two physical units PU are configured (or, prepared). A physical unit may be filled with SRD-attached compressed data without a space/fragmentation, as illustrated in FIG. 5, regardless of the manner in which SRD-attached compressed data is stored in the storage media 1000.

According to an exemplary embodiment of the present general inventive concept, header information SRD may be formed of a bit string of a pattern that is not included in the compressed data. For example, the header information SRD may be generated using the Huffman algorithm such that it is formed of a bit string of a pattern that is not included in compressed data. Addition of the header information SRD is made by the compression block 2500 or by the CPU 2300. The header information SRD can be formed to include additional information together with information (or mark) indicative of a start of compressed data. For example, the additional information may include information indicating the order of logical units constituting uncompressed data, a length of compressed data, among other information.

According to an exemplary embodiment of the present general inventive concept, a logical unit LU is the same as or smaller in size than a physical unit PU. Further, it is possible to change the size of a physical unit PU. For example, the size of a physical unit can be set to be the same as a sector, a page, a block, a super-block, or the like, according to whatever constraints might be available in the non-volatile memory as used in the storage media 1000. If a non-volatile memory has an M-plane array structure (M being an integer equal to or greater than 2), a super-block can be formed of M memory blocks each in M planes in the same row.

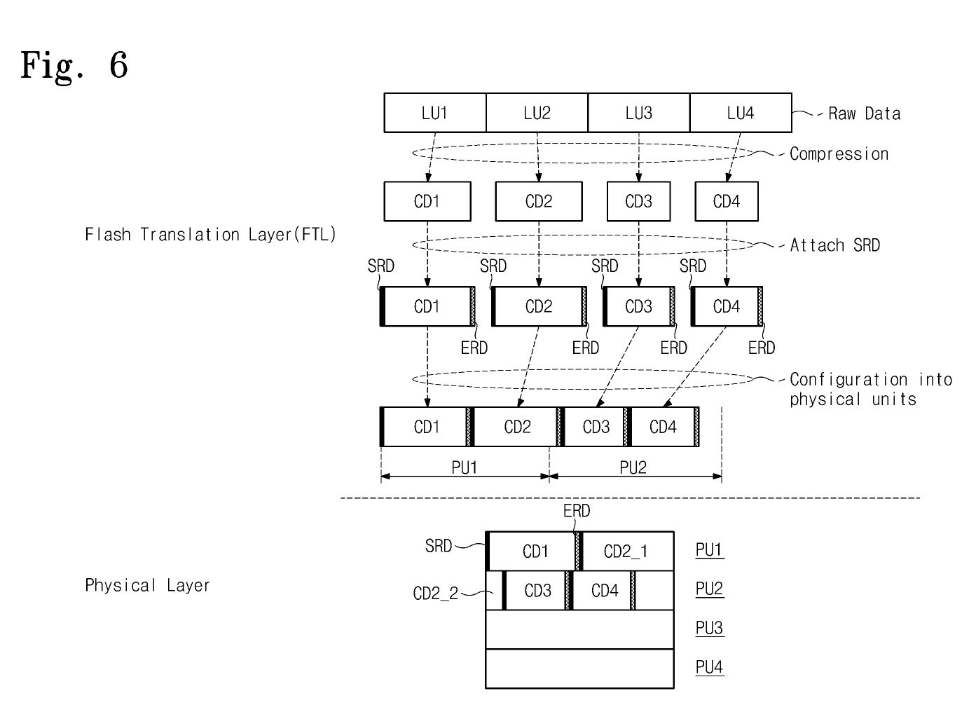

FIG. 6 is a diagram showing data flow according to another write method of the present general inventive concept.

The write method of FIG. 6 is substantially identical to that as shown and described in regard to FIGS. 4 and 5 except for the following differences, discussed below, and therefore a discussion of the entire method has been omitted for the dual purposes of brevity and clarity. According to an exemplary embodiment of the present general inventive concept, the write method described in FIG. 4 may include adding header information SRD and footer information ERD to the compressed data. That is, in operation S120 of FIG. 4, both header information SRD and footer information ERD regarding the compressed data is added to the compressed data. According to an exemplary embodiment, the footer information ERD can be used as information (or, a mark) indicative of an end of compressed data CD. Similar to the header information SRD, footer information ERD may be formed of a bit string of a pattern that is not included in compressed data. For example, the footer information ERD may be generated using the Huffman algorithm such that it is formed of a bit string of a pattern that is not included in compressed data. Addition of the header and footer information SRD and ERD may be conducted by a compression block 2500 or by CPU 2300.

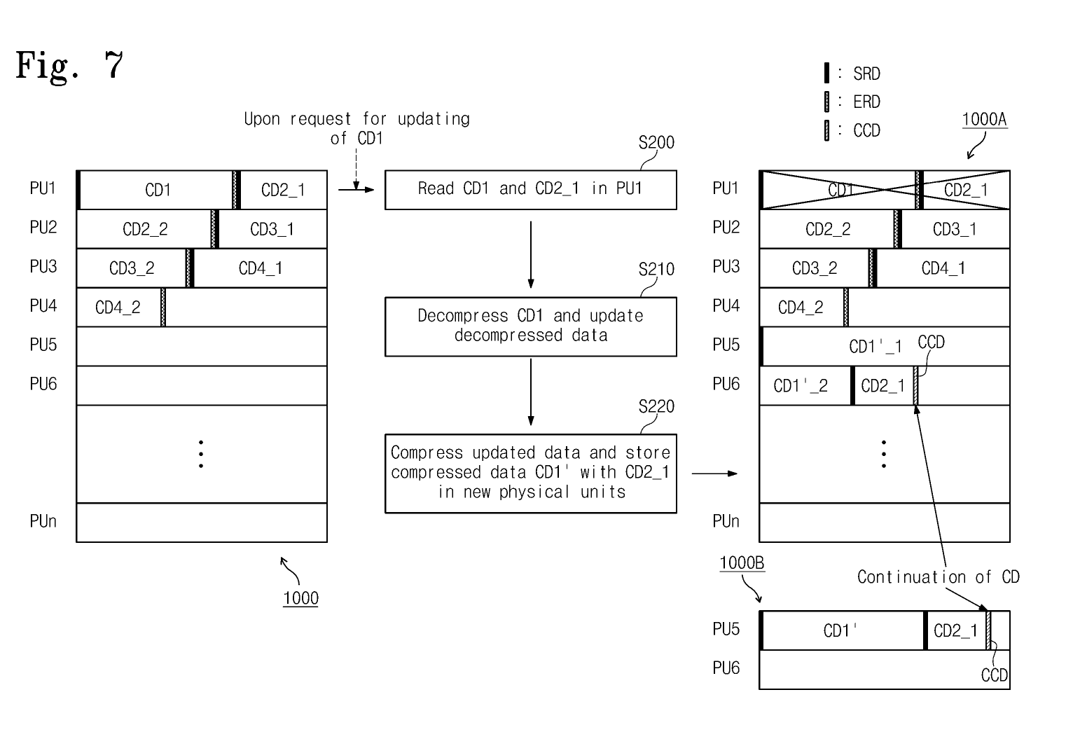

FIG. 7 is a diagram describing a write operation of a data storage device according to another exemplary embodiment of the present general inventive concept. The write operation of a data storage device according to another exemplary embodiment of the inventive concept will be more fully described below with reference to accompanying drawings.

A write operation of a data storage device according to another exemplary embodiment of the inventive concept, for example, includes an update operation to data stored in a storage media 1000, that is, compressed data. For example, it is assumed that an update operation to data (for example, CD1) stored in the storage media 1000 is requested from an external device (that is, host). Raw data to be updated may be stored in a buffer 2400 via the first interface 2100. Then, in operation S200, a read operation occurs with respect to a physical unit PU1 that includes data CD1 that is to be updated. According to the read result, both compressed data CD1 and CD2_1 of logical units LU1 and LU2 are read out from the physical unit PU1. The read data CD1 and CD2_1 is temporarily stored in the buffer 2400 through the second interface 2200. Because an update operation has been requested only for compressed data CD1 that corresponds to a logical unit LU1, the partial data CD2_1 of compressed data CD2 that corresponds to a logical unit LU2 is only read out. That is, no read operation is carried out with respect to the remaining data CD2_2 of the compressed data CD2 corresponding to the logical unit LU2.

In operation S210, a compression block 2500 decompresses compressed data CD1 based on header information SRD and footer information ERD, and the appropriate part of the decompressed data is revised with the new data such that CD1 is now updated. In operation S220, the compression block 2500 compresses updated data CD1, and the compressed data CD1′ is configured to one or more physical unit(s) together with the compressed data CD2_1. As above described, header information SRD and/or footer information ERD may be added to the compressed data CD1′ of the logical unit LU1. The compressed data CD1′ and CD2_1 configured to one or more physical units may be stored in one or more new physical units of the storage media 1000. For example, the compressed data CD1′ and CD2_1 can be stored in two physical units. Alternatively, the compressed data CD1′ and CD2_1 can be stored in one physical unit. The former case corresponds to the situation in which the amount of compressed data CD1′ increases. This case is shown in FIG. 7 as 1000A. In this case, wherein the amount of data in CD1′ has increased, the compressed data CD1 corresponding to the logical unit LU1 is stored in physical units PU5 and PU6, and the partial data CD2_1 of the compressed data CD2 corresponding to the logical unit LU2 is stored in a physical unit PU6. In the case that the compressed data CD1′ and CD2_1 is stored in one physical unit, then the amount of compressed data CD1′ has decreased, and this is shown in FIG. 7 as 1000B. In this latter case, the compressed data CD1′ and the partial data CD2_1 are stored in a physical unit PU5.

According to a further exemplary embodiment, as illustrated in FIG. 7, a mark CCD that is indicative of a continuation of compressed data is added to the partial data CD2_1 of compressed data CD2 which is stored following the compressed data CD1′ and corresponds to the logical unit LU2. The mark CCD means that there is another portion of the data, and that the remaining portion of the compressed data CD2 is stored in another physical unit.

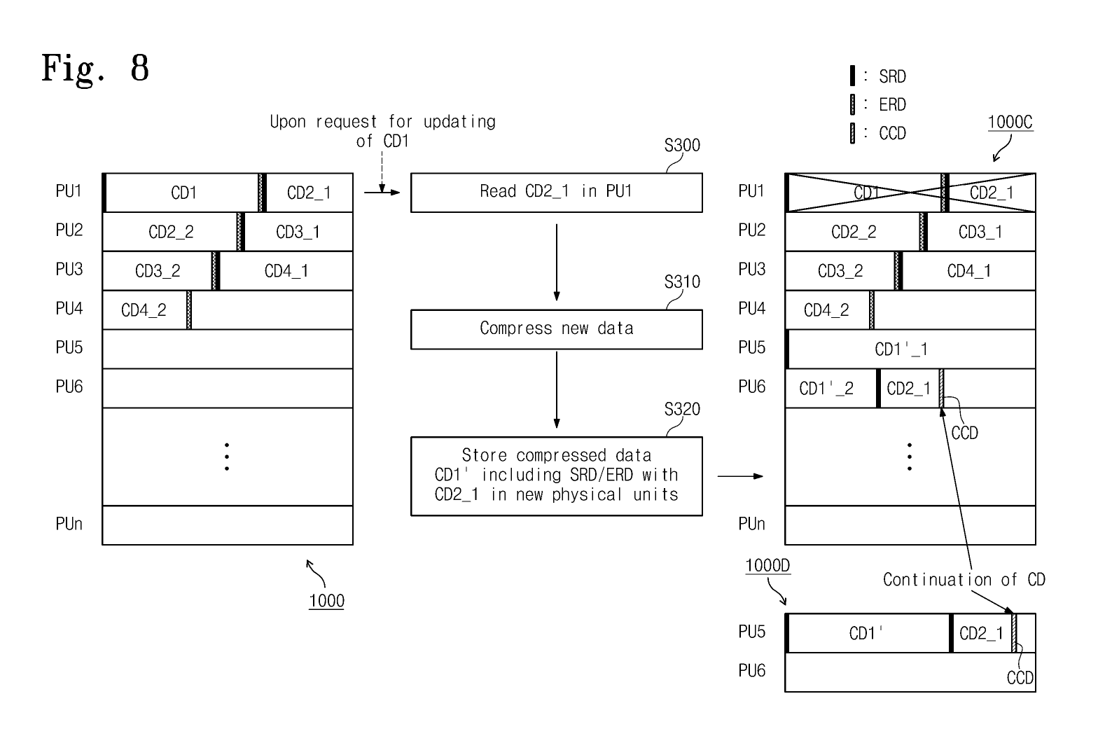

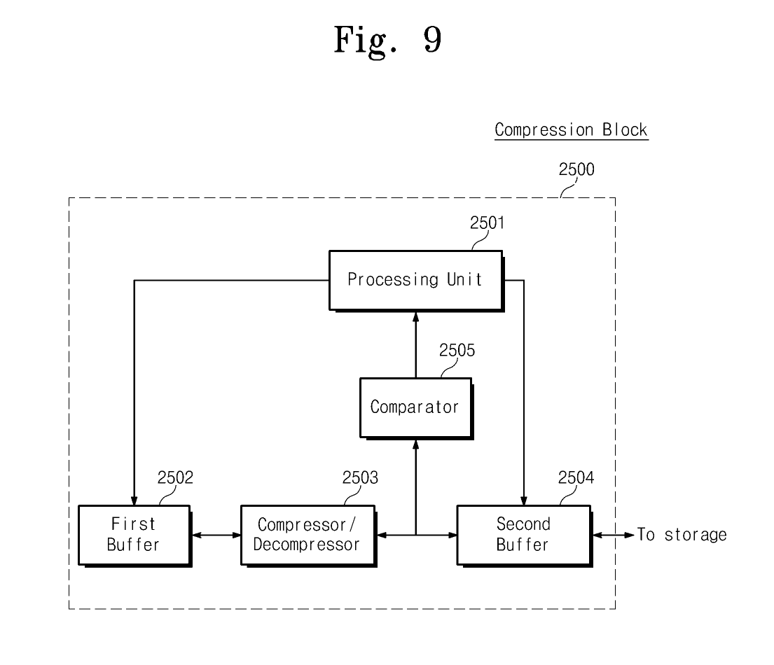

FIG. 8 is a diagram describing a write operation of a data storage device according to still another exemplary embodiment of the present general inventive concept. The write operation of a data storage device according to still another exemplary embodiments of the inventive concept will be more fully described below with reference to the accompanying drawings.

A write operation of a data storage device according to another embodiment of the present general inventive concept, for example, can include an update operation to the data stored in a storage media 1000, that is, compressed data. For example, presume that an update operation is requested from an external device (that is, a host) not to just a portion or part of some data (for example, compressed data CD1) stored in the storage media 1000, but to all of the compressed data CD1. Raw data to be updated is stored in a buffer 2400 through the first interface 2100. In operation S300, there is carried out a read operation with respect to a physical unit PU1 including data CD1 to be updated. As a read result, compressed data CD2_1 of a logical unit LU2 in the physical unit PU1 is read out. Since an update operation to all of compressed data CD1 is requested, compressed data CD1 is not read out from the physical unit PU1.

In operation S310, a compression block 2500 compresses new data of the logical unit LU1. That is, all of the original CD1 data is to be disregarded and replaced by an entire new data CD1 that corresponds to logical unit LU1. As described above, header information SRD and/footer information ERD may be added to compressed new data CD1′ of the logical unit LU1. In operation S320, the compressed new data CD1′ may be configured to one or more physical units together with the compressed data CD2_1. The compressed new data CD1′ and compressed data CD2_1 is configured to one or more physical units and may be stored in the storage media 1000. For example, the compressed new data CD1′ and compressed data CD2_1 can be stored in two physical units. Alternatively, the compressed new data CD1′ and compressed data CD2_1 can be stored in one physical unit. The former case is the situation in which the amount of compressed new data CD1′ increases as marked by 1000C in FIG. 8. In this case, the compressed new data CD1′ corresponding to the logical unit LU1 is stored in physical units PU5 and PU6, and partial data CD2_1 of compressed data CD2 corresponding to a logical unit LU2 is stored in a physical unit PU6. The latter case is the situation in which the amount of compressed new data CD1 decreases as marked by 1000D in FIG. 8. In this case, the compressed new data CD1′ corresponding to the logical unit LU1 and partial data CD2_1 of compressed data CD2 corresponding to a logical unit LU2 are stored in a physical unit PU5.

In an exemplary embodiment, as illustrated in FIG. 8, a mark CCD indicative of a continuation of compressed data is added to the partial data CD2_1 of the compressed data CD2 which is stored following the compressed data CD1′ and corresponds to the logical unit LU2. The mark CCD means that the remaining portion of the compressed data CD2 is stored in another physical unit.

FIG. 9 is a block diagram showing a compression block 2500 illustrated in FIG. 2 according to an exemplary embodiment of the present general inventive concept.

Referring to FIG. 9, a compression block 2500 includes a processing unit 2501, a first buffer 2502, a compressor/decompressor 2503, a second buffer 2504, and a comparator 2505. The first buffer 2502 stores raw data of at least one logical unit LU under the control of the processing unit 2501. The compressor/decompressor 2503 compresses raw data received from the first buffer 2502. The compressed data is stored in the second buffer 2504 under the control of the processing unit 2501. The second buffer 2504 temporarily stores compressed data to be stored in at least one physical unit. The compressor/decompressor 2503 is configured to release compressed data transferred through the second buffer 2504. The comparator 2505 is configured to detect a number of bit patterns in the uncompressed data, that are identical to the bit pattern included in the header information SRD added to compressed data CD, from data compressed by the compressor/decompressor 2503. The detected pattern number is provided to the processing unit 2501. For example, the comparator can determine that a number, or amount, bit patterns that are the same as a first bit pattern is equal to N, wherein N can be 1 or greater.

The processing unit 2501 configures header information SRD based on the detected pattern number from the comparator 2505 and adds the header information SRD to compressed data CD stored in the second buffer 2504. The header information SRD may include information (bit pattern) indicative of a start of compressed data, information indicative of a detected pattern number, the order that a logical unit of compressed data belongs to raw data, among other types of information. Furthermore, information indicative of the detected pattern number can also be used to detect an end of compressed data, upon reading of compressed data from a physical unit. The processing unit 2501 is configured to add footer information ERD to compressed data CD together with the header information SRD. The footer information ERD is used to detect an end of compressed data, upon reading of compressed data from a physical unit. If the footer information ERD is added, the comparator 2505 detects the number of patterns being identical to the footer information ERD and adds the detected pattern number to the header information SRD.

In an exemplary embodiment, the processing unit 2501 is independent from CPU 2300 described in FIG. 2. The first and second buffers 2502 and 2504 are formed of a part of a buffer 2400 illustrated in FIG. 2, or are formed to be independent from the buffer 2400.

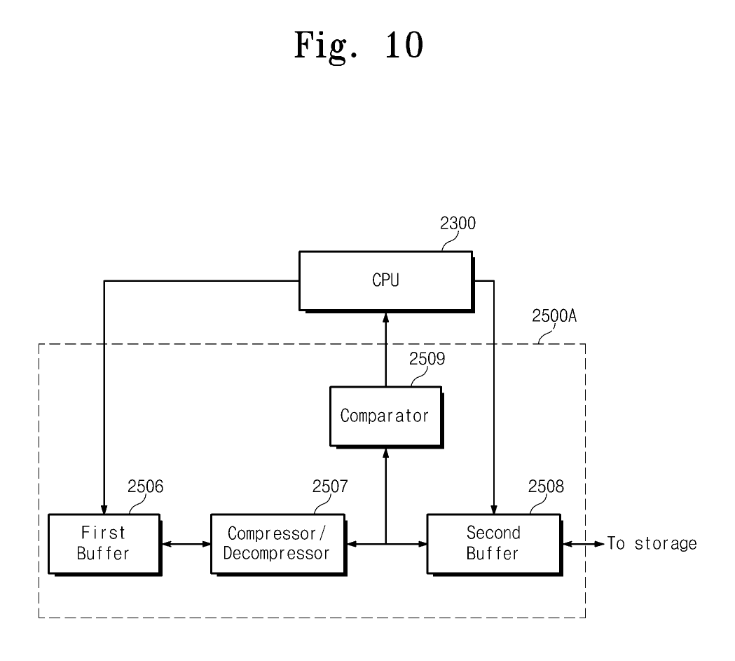

FIG. 10 is a block diagram showing a compression block illustrated in FIG. 2 according to another exemplary embodiment of the present general inventive concept.

Referring to FIG. 10, a compression block 2500A includes first buffer 2506, a compressor/decompressor 2507, second buffer 2508, and a comparator 2509. The compression block 2500A illustrated in FIG. 10 is substantially identical to that illustrated in FIG. 9 except that a processing unit 2501 in FIG. 9 is removed, and a detailed description thereof is thus omitted for the dual purposes of clarity and brevity. Operations (for example, division of raw data into logical units, addition of header/footer information, etc.) executed by a processing unit 2501 in FIG. 9 are made under the control of CPU 2300 as described in FIG. 2.

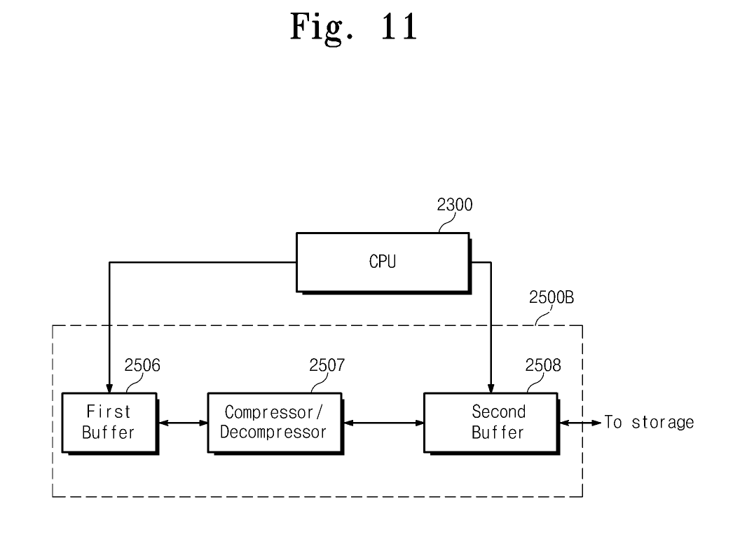

FIG. 11 is a block diagram showing a compression block illustrated in FIG. 2 according to still other exemplary embodiments of the present general inventive concept.

The compression block 2500B illustrated in FIG. 11 is identical to that illustrated in FIG. 10 except that comparator 2509 in FIG. 10 is removed, and a detailed description thereof is thus omitted for the dual purposes of clarity and brevity. According to a further exemplary embodiment, header information added to compressed data CD may further include length information of compressed data CD. The length information of compressed data CD is used to determine an end of compressed data when a read operation is carried out. The length information of compressed data CD can be used in any of the alternative embodiments discussed herein.

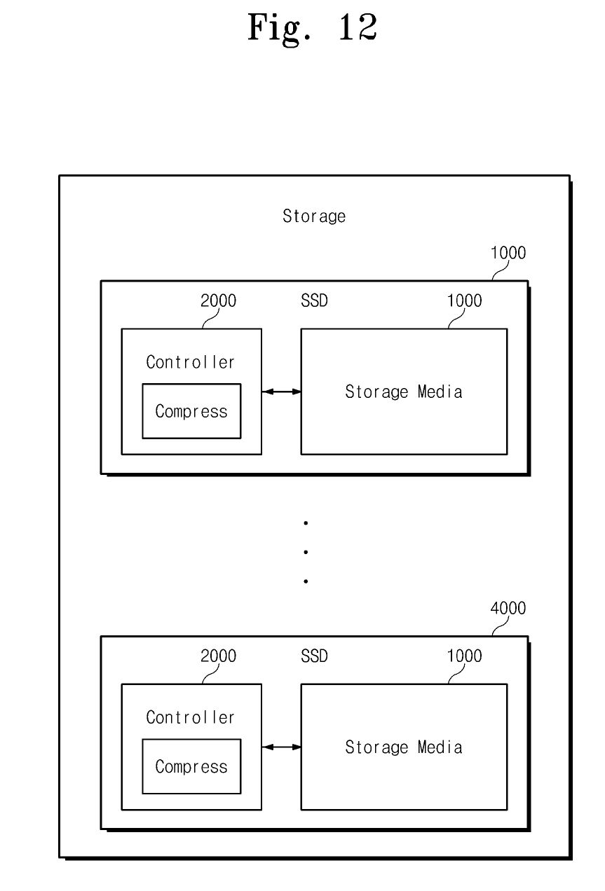

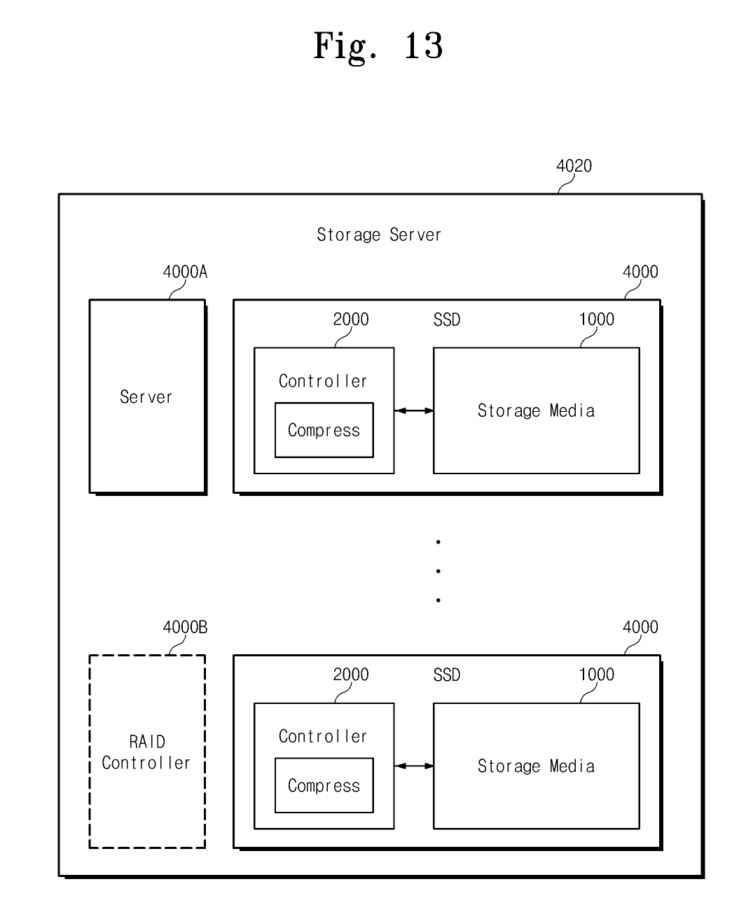

A data storage device according to an exemplary embodiment of the inventive concept may be a solid state drive SSD. A block diagram showing a storage apparatus 4010 using an SSD 4000 as a data storage device is illustrated in FIG. 12, and a block diagram showing a storage server 4020 using the SSD 4000 as illustrated in FIG. 12, is illustrated in FIG. 13.

An SSD 4000 according to an exemplary embodiment of the inventive concept can be used as a storage for use with a controller, computer, and server, among other types of processing devices. As illustrated in FIG. 12, storage apparatus 4010 includes a plurality of solid state drives (SSD) 4000 which are configured to be substantially the same as those shown and described with respect to FIG. 3. The SSD 4000 according to an exemplary embodiment of the inventive concept can be used in a storage sever 4020. As illustrated in FIG. 13, a storage server 4020 can include a plurality of solid state drives 4000, which are configured to be substantially the same as shown in FIG. 12, and a server 4000A. Further, it is well known by those of ordinary skill in the art that a RAID controller 4000B can be provided in the storage server 4020. A RAID controller (Redundant Array of Independent Disks) 4000B can provide increased storage functions and reliability through redundancy. This can be achieved by combining one or more disk drive components into a logical unit, such that data can be distributed across the drives in one of several ways.

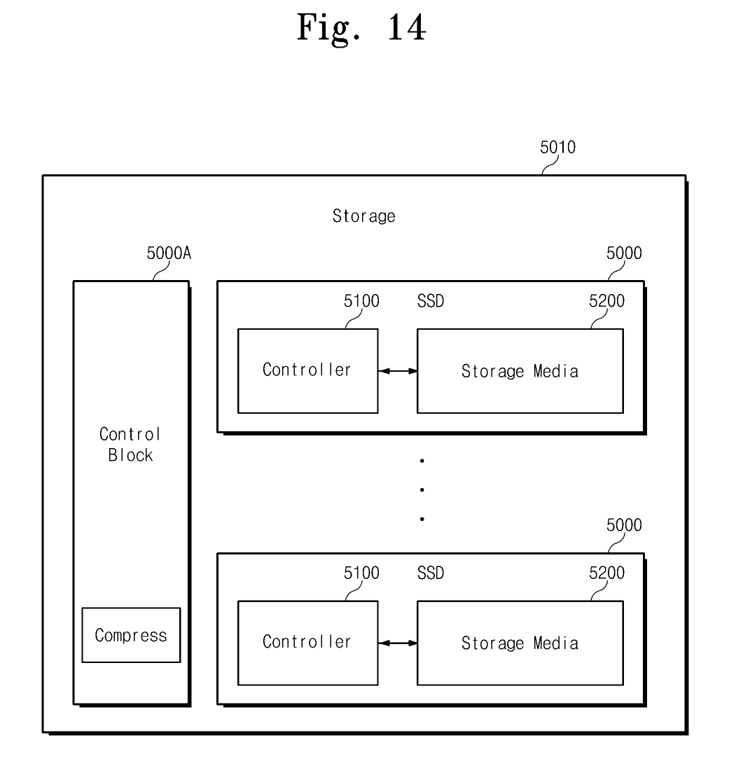

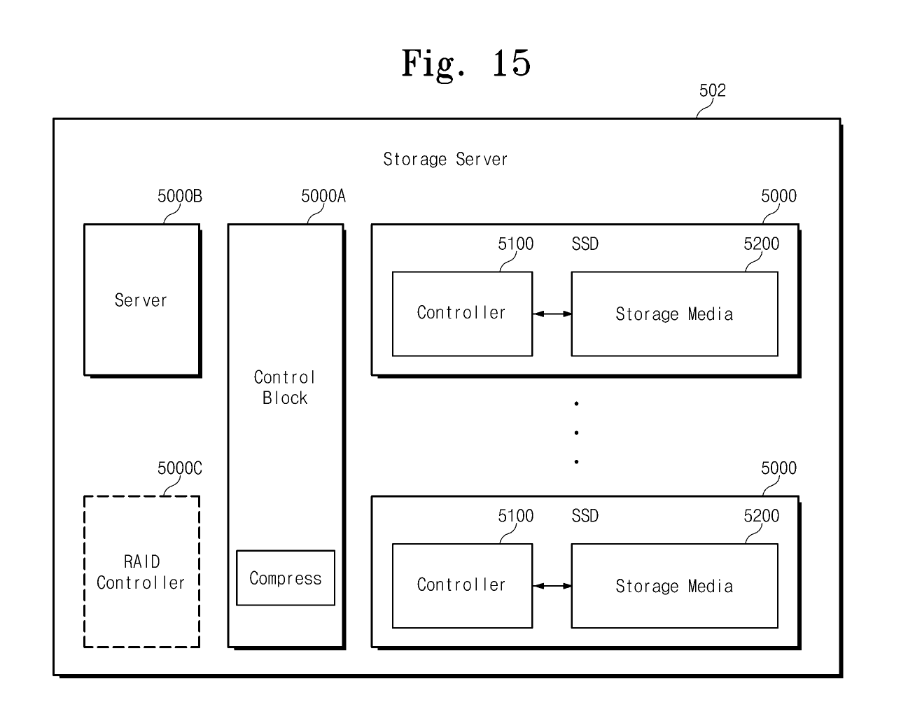

FIG. 14 is a block diagram showing a storage apparatus 5010 according to another exemplary embodiment of the present general inventive concept, and FIG. 15 is a block diagram showing a storage server 4040 using the storage apparatus 4030 of FIG. 14.

Referring to FIG. 14, a storage apparatus 5010 comprises a plurality of solid state drives 5000 and a control block 5000A. Each of the solid state drives 5000 includes a controller 5100 and a storage media 5200. The controller 5100 is configured to perform an interface function with the storage media 5200. The solid state drives 5000 are controlled by the control block 5000A. The control block 5000A is configured to perform the functions as described above (for example, division of raw data into logical units, addition of header/footer information, among others). The storage apparatus 5010 shown in FIG. 14 can be used as a storage server 5020. As illustrated in FIG. 15, a storage server 5020 includes a server 5000B, a control block 5000A, and one or more an SSDs 5000, wherein each of the SSDs 5000 are configured to be substantially identical to the SSD 5000 shown in FIG. 14. Further, it is well-known to those of ordinary skill in the art that a RAID controller 5000C can be provided in the storage server 5020.

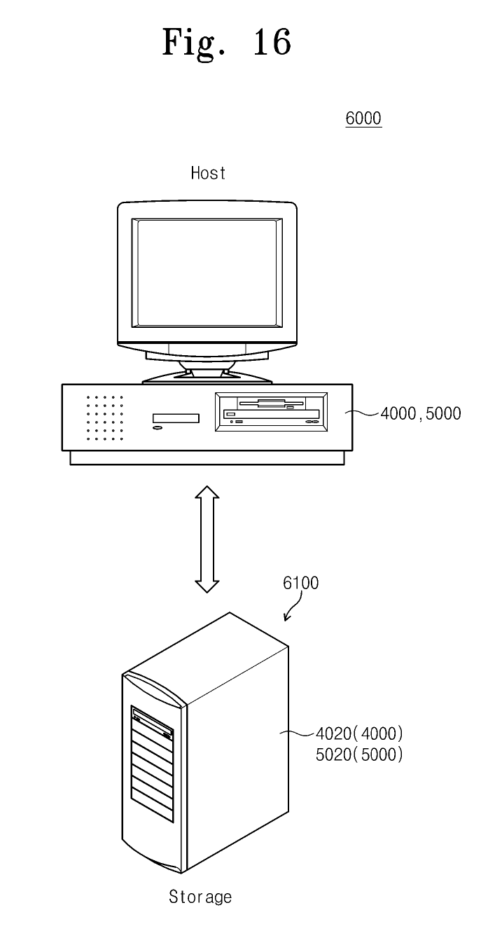

FIGS. 16 to 18 are diagrams showing systems to which a data storage device according to exemplary embodiments of the present general inventive concept is applied.

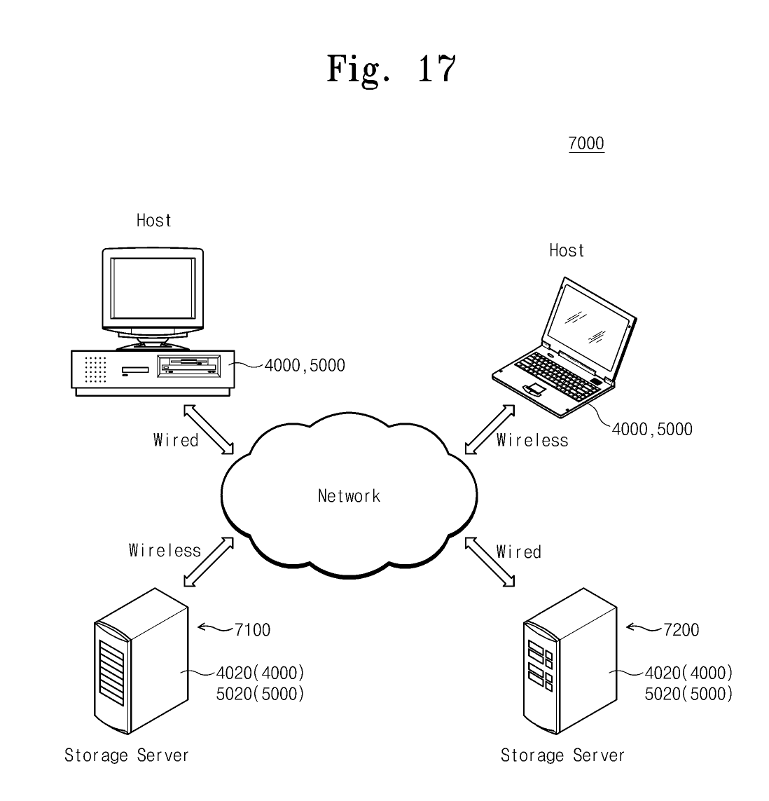

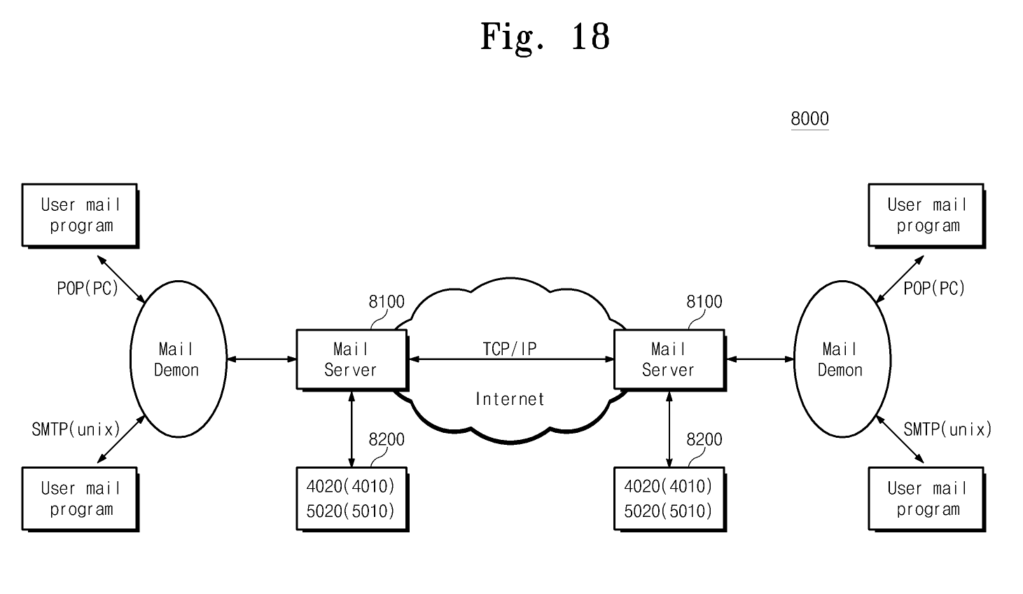

Referring to FIG. 16, a host device shown in system 6000 can use one or more solid state drives 4000, 5000, as shown and discussed with regard to FIGS. 12-15 that include a data storage device according to exemplary embodiments of the inventive concept. As further illustrated in FIG. 16, a system 6000 can include a storage 6100 which communicates with the host in a wire or wireless manner, and the storage 6100 can include storage servers 4020 and 5020. Referring to FIG. 17, system 7000 includes one or more of host devices connected to a network in either a wired or wireless fashion. Either or both of host devices can include one or more of SSDs 4000, 5000. SSDs 4000, 5000 can include a data storage device according to exemplary embodiments of the inventive concept. System 7000 can further include storage servers 7100 and 7200, each of which can communicate with each of the one or more hosts in a wire or wireless manner through a network, such as an internet, though many other types of networks can also be used. Each of storage servers 7100, 7200, can be configured as storage servers 4020 and 4040, according to an exemplary embodiment of the present general inventive concept. Referring now to FIG. 18, a solid state drive 4000, 5000 including a data storage device according to exemplary embodiments of the inventive concept can be applied to a mail server 8100 in the system 8000. Each of mail servers 8100 can use storage servers 8200, each of which can include SSDs 4000, 5000 according to the exemplary embodiments of the present general inventive concept discussed above.

In an exemplary embodiment, a compression block 2500 of a controller 2000 may include one of the following compression algorithms or a combination of two or more compression algorithm. Compression algorithms can include LZ77&LZ78, LZW, Entropy encoding, Huffman coding, Adaptive Huffman coding, Arithmetic coding, DEFLATE, JPEG, among other types of compression algorithms.

In an exemplary embodiment, the first interface 2100 of a controller 2000 may be formed of one of computer bus standards, storage bus standards, and iFCPPeripheral bus standards, or a combination of two or more standards. The computer bus standards can include S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, among other bus types. The storage bus standards may include ST-506, ESDI, SMD, Parallel ATA, DMA, SSA, HIPPI, USB MSC, FireWire(1394), Serial ATA, eSATA, SCSI, Parallel SCSI, Serial Attached SCSI, Fibre Channel, iSCSI, SAS, RapidIO, FCIP, among other bus standard types. The iFCPPeripheral bus standards may include Apple Desktop Bus, HIL, MIDI, Multibus, RS-232, DMX512-A, EIA/RS-422, IEEE-1284, UNI/O, 1-Wire, I2C, SPI, EIA/RS-485, USB, Camera Link, External PCIe, Light Peak, Multidrop Bus, among other iFCPPeripheral bus standard types.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A data storage device comprising:
a storage media; and
a controller to compress raw data to be stored in the storage media,
wherein the controller adds header information to the compressed data.

2. The data storage device of claim 1, wherein the controller configures physical units of the storage media by the compressed data.

3. The data storage device of claim 2, wherein the controller controls the storage media so that the compressed data having the header information is stored continuously in physical units of the storage media.

4. The data storage device of claim 3, wherein a unit of the compressed data is formed of a logical unit, and a size of the logical unit is identical to or less than a size of a physical unit of the storage media.

5. The data storage device of claim 4, wherein the header information includes information indicative of a start of the compressed data of each of the logical units stored in each physical unit of the storage media.

6. The data storage device of claim 5, wherein the information indicative of the start of the compressed data is formed of a bit pattern not included in the compressed data of each of the logical units.

7. The data storage device of claim 5, wherein the information indicative of the start of the compressed data is formed of a bit pattern determined by the controller.

8. The data storage device of claim 7, wherein the header information further includes information indicative of the number of bit patterns, being identical to the bit pattern, among the compressed data.

9. The data storage device of claim 6, wherein the controller includes a compression block to compress the raw data and a CPU to manage a mapping relationship between the raw data and the compressed data,
wherein the compression block includes a processing unit; a first buffer to store raw data of the logical unit; a compressor/decompressor to compress the raw data stored in the first buffer; and a second buffer to store data compressed by the compressor/decompressor, the processing unit adding the header information to the compressed data stored in the second buffer.

10. The data storage device of claim 9, wherein the header information includes information indicative of the start of the compressed data of each logical unit stored in each physical unit of the storage media and length information indicative of a length of the compressed data of each logical unit.

11. The data storage device of claim 9, wherein the compression block further comprises:
a comparator which detects the number of bit patterns being identical to a bit pattern included in the header information and being included in the data compressed by the compressor/decompressor.

12. The data storage device of claim 11, wherein the processing unit adds header information to the compressed data, the header information including information indicative of the start of the compressed data of each logical unit stored in each physical unit of the storage media and information indicative of the detected bit pattern number.

13. The data storage device of claim 1, wherein the controller adds footer information to the compressed data, the footer information being information indicative of an end of the compressed data.

14. The data storage device of claim 1, wherein the controller comprises:
a CPU;
a buffer configured to store data to be stored in the storage media; and
a compression block configured to compress data stored in the buffer,
wherein adding of header information to compressed data is performed under the control of the CPU, and the header information includes information indicative of a start of the compressed data of each logical unit stored in each physical unit of the storage media.

15. A method of writing data to a data storage device, the data storage device including a storage media, and a controller to control the storage media, the write method comprising:
configuring raw data to be stored in the storage media according to logical units;
compressing the raw data of the logical units, respectively;
adding header information to the compressed data of each of the logical units; and
continuously storing the compressed data of the respective logical units each having the header information in physical units of the storage media.

16. The method of claim 15, wherein when the compressed data of the respective logical units each having the header information are continuously stored in the physical units of the storage media, compressed data of a logical unit is partially stored in two physical units of the storage media.

17. The method of claim 16, further comprising:
upon receipt of an update request to compressed data stored in a first physical unit of the two physical units, reading compressed data stored in the first physical unit; releasing compressed data of a logical unit corresponding to the update request; updating the released data, and then compressing the updated data; and storing the updated compressed data and compressed data of a logical unit regardless of the update request among the read compressed data, in one or more new physical units of the storage media.

18. The method of claim 17, wherein a mark indicative of a continuation of compressed data is added to the compressed data of a logical unit regardless of the update request among the read compressed data.

19. The method of claim 16, further comprising:
upon receipt of an update request to compressed data stored in a first physical unit of the two physical units, reading compressed data stored in the first physical unit; compressing raw data of a logical unit corresponding to the update request; and storing the updated compressed data and compressed data of a logical unit regardless of the update request among the read compressed data, in one or more new physical units of the storage media.

20-22. (canceled)

23. A data storage device, comprising:
a storage media; and
a compression block to receive raw data and divide the received raw data into one or more corresponding logic units, to compress the received raw data according to the corresponding logic unit, to store the compressed raw data into physical units in the storage media, wherein a size of the physical unit corresponds to a size of the logical units according to a first relationship, and to update stored compressed data, wherein when an update of first stored compressed data updates less than the entire first stored compressed data, the first stored compressed data to be updated is retrieved from a first physical unit along with a second stored compressed data that is stored in the first physical unit.

24-28. (canceled)
